(19) United States
(12) Patent Application Publication
(10) Pub. No.: US 2007/0172601 A1
(43) Pub. Date: Jul. 26, 2007

(54) System and method for vaporizing powders

(76) Inventors: Sergei Putvinski, La Jolla, CA (US); Michael P. Meekins, San Diego, CA (US); Oleg Feygenson, San Diego, CA (US); Karl R. Umstadter, San Diego, CA (US)

Correspondence Address: NEIL K. NYDEGGER;NYDEGGER & ASSOCIATES, 348 Olive Street, San Diego, CA, 92103, US

(21) Appl. No.: 11/336,580

(22) Filed: Jan. 20, 2006

(51) Int. Cl. C23C 8/00; B05D 3/00

(52) U.S. Cl. 427/561; 427/585

(57) ABSTRACT

A system for vaporizing a powder material incorporates a laser source with an optical arrangement for generating and focusing a laser beam to a focal point. The beam is characterized by having a region with a converging/diverging angle (α), respectively upstream/downstream from the focal point. It also has a power density above a predetermined value within the region. A conduit is provided with a channel, and the laser beam is focused to conform to the region in the channel. A nozzle then directs powdered material into the laser beam at a location upstream from the region for vaporization of the powder material by the laser beam during its transit through the region.

### FIELD OF THE INVENTION

The present invention pertains generally to systems and methods for vaporizing powdered materials. More particularly, the present invention pertains to systems that employ laser beams for creating vaporization-level power densities for powdered materials at low gas pressures. The present invention is particularly, but not exclusively useful as a system or a method wherein the vaporizing laser beam and the region wherein the powdered materials are to be vaporized are configured to dimensionally conform to each other.

### BACKGROUND OF THE INVENTION

It is often desirable, and frequently required, that a compound be dissociated into its constituent elements, or components, before it can be further processed. In many applications, the necessary dissociation can be accomplished chemically; in others it may be accomplished mechanically. In yet other, more complex applications, it may be best to first vaporize the target material before an effective separation of the constituent components is accomplished. When vaporization is involved, however, there are specific concerns about how best to heat the material for vaporization, and how to maintain an effective throughput of the material in the process.

While there are many obvious ways in which a material can be heated for vaporization, the use of lasers for this purpose has recently been of particular interest. Lasers have certain specific operational limitations, however, that must be accounted for if they are to be effectively used to vaporize a target material. One such limitation involves the spatial dimensions of the vaporizing laser beam. Specifically, the power density that is necessary for the vaporization of a target material is, for practical reasons, effectively confined to a relatively small spatial volume in a laser beam. The rate of vaporization is thereby limited. A consequence of this is that when relatively large volumes of target material are to be vaporized, the entire volume of the material cannot be vaporized at the same time. Further, large volumes of target material are also susceptible to the creation of unwanted molten layers and splashing of liquid material. This limitation also makes materials that have high coefficients of thermal expansion particularly susceptible to thermal shock. To overcome these difficulties, relatively complex mechanisms for delivery of the target material to the laser beam are required.

Unlike large volume target materials, however, very small volumes of target material may be able to avoid aspects of the above-mentioned difficulties, and do so without requiring the use of relatively complex delivery systems. In this context, a small volume target material is considered to be any particle of the material having a diameter “D” that is less than the diameter “d” of the laser beam being used to vaporize the material (i.e. D<d). Of particular importance here is the fact that small volume targets (e.g. particles such as ceramic powders) are relatively easy to deliver and, thus, lend themselves to higher throughput operations. Further, it is known that small volume particles tend to suppress such adverse effects as the “rocket force”, that might otherwise interfere with a laser vaporization process.

In light of the above, it is an object of the present invention to provide a system for vaporizing a powder material that has high throughput capability. Another object of the present invention is to provide a system for vaporizing ceramic powders that has relatively uncomplicated delivery requirements for the target material. Still another object of the present invention is to provide a system for vaporizing powder material that is easy to use, is relatively simple to manufacture and is more efficient than previous methods.

### SUMMARY OF THE INVENTION

In accordance with the present invention, a system for vaporizing a powder material with laser power requires dimensionally configuring a laser beam to accomplish the vaporization. Specifically, this is done in a manner that conforms the beam to a vaporization region wherein the powder material is to be vaporized. Major components of the system include: a laser source for generating the laser beam; an optical arrangement for focusing the laser beam to a focal point in a vaporization region; and a nozzle for directing the powder material through the focal point in the vaporization region.

In addition to the components mentioned above, an important component of the system for the present invention is an elongated, conduit that is formed with a channel. Specifically, the conduit has an upstream proximal end and a downstream distal end, with the channel extending between these two ends. Structurally, the channel is characterized by having a proximal section and a distal section. In more detail, the proximal section is tapered with a diminishing cross-sectional area in a distal direction toward the center of the channel. Also, the conduit is formed with at least one fluid passageway through which water can be passed to cool the conduit.

The system of the present invention also includes an elongated, hollow chamber having a first end and a second end. A window may be mounted at the first end of the chamber, and the second end of the chamber is affixed to the proximal end of the conduit. There is also a source of gas that is connected in fluid communication with the chamber. With this connection, gas is directed from the source of gas, into the chamber. Gas selection is dependent on desired results. Also, in a preferred embodiment of the present invention, a portion of the nozzle is formed in the conduit, so that the powder material to be vaporized is introduced into the channel in the proximal section of the conduit.

For the operation of the system of the present invention, the laser beam is directed into the channel of the conduit. Specifically, the laser beam is focused to a focal point that is located in the channel, between the proximal section and the distal section. Importantly, when so focused, the laser beam is dimensionally configured to substantially conform to the shape of the channel in both its proximal and distal sections. In particular, the laser beam converges toward the focal point in the proximal section, and diverges from the focal point in the distal section, at an angle “α”.

As indicated above, when the laser beam is directed into the channel of the conduit, the laser beam establishes a vaporization region in the channel that has a converging/diverging angle (α). Further, the vaporization region will be within a distance (L) from the focal point, and will extend both upstream and downstream from the focal point. For the purposes of the present invention, when so focused, the laser beam will have a power density within the region that is in a range sufficient for evaporation of the particles. A beneficial consequence of this power density and the conformation of the laser beam with the channel is that the laser beam will help clean the channel of the conduit.

Once the vaporization region has been established by the laser source in the channel of the conduit, the source of gas can be activated to direct gas into the chamber. At this time, the nozzle can also be activated to direct the powdered material into the vaporization region of the laser beam. Specifically, as implied above, the powdered material is injected into the laser beam at a location upstream from the vaporization region. The laser beam then vaporizes the material during its transit through the vaporization region. During this operation, the gas pressure that is created by the source of gas in the chamber will transport the powder material through the channel and, at the same time isolate the window, if used, from vaporized powder material.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a system for vaporizing powdered materials with a laser beam;

FIG. 2 is a cross-sectional view of the system as seen along the line 2-2 in FIG. 1; and

FIG. 3 is a magnified view of the conduit of the system as seen in FIG. 2.

### DESCRIPTION OF THE PREFERRED EMBODIMENTS

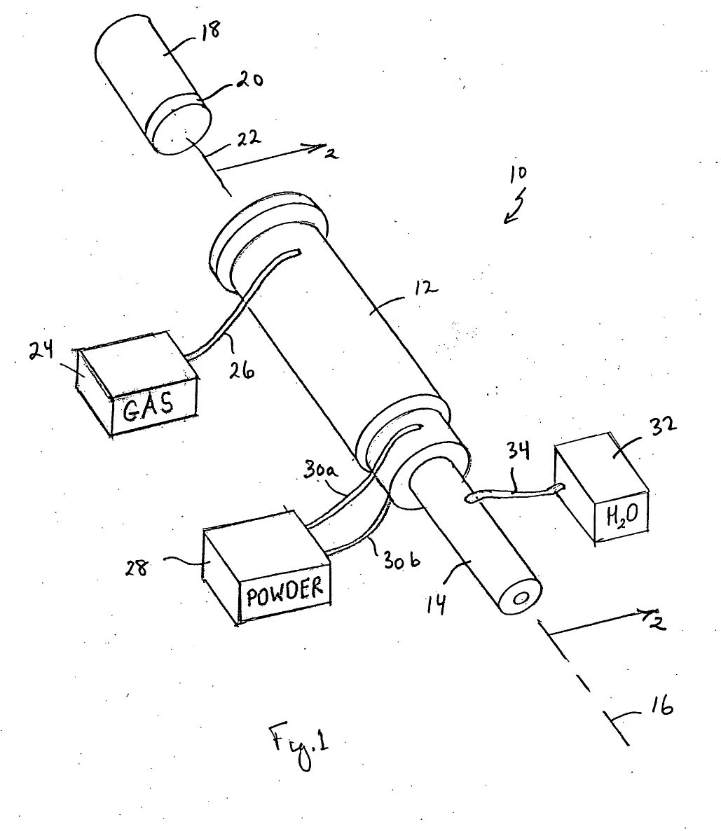

Referring initially to FIG. 1, a system for vaporizing powdered material in accordance with the present invention is shown and is generally designated 10. As shown, the system 10 includes a hollow elongated chamber 12 that is joined to an elongated copper conduit 14. Both the chamber 12 and the conduit 14 are aligned along a common longitudinal axis 16. FIG. 1 also shows that the system 10 incorporates a laser source 18 with an optical arrangement 20 that are positioned to direct and focus a laser beam 22 through the chamber 12 and conduit 14 along the axis 16. It is also shown in FIG. 1 that the system 10 includes a source of gas 24 that is connected in fluid communication with the chamber 12 via a line 26. Also, a source 28 of a powder material (not shown) is connected via lines 30a and 30b with the conduit 14 for transfer of the powder material from the source 28 to the conduit 14. Further, a source 32 of a liquid coolant (e.g. water, H₂O) can be provided, and connected in fluid communication with the conduit 14 via a fluid line 34.

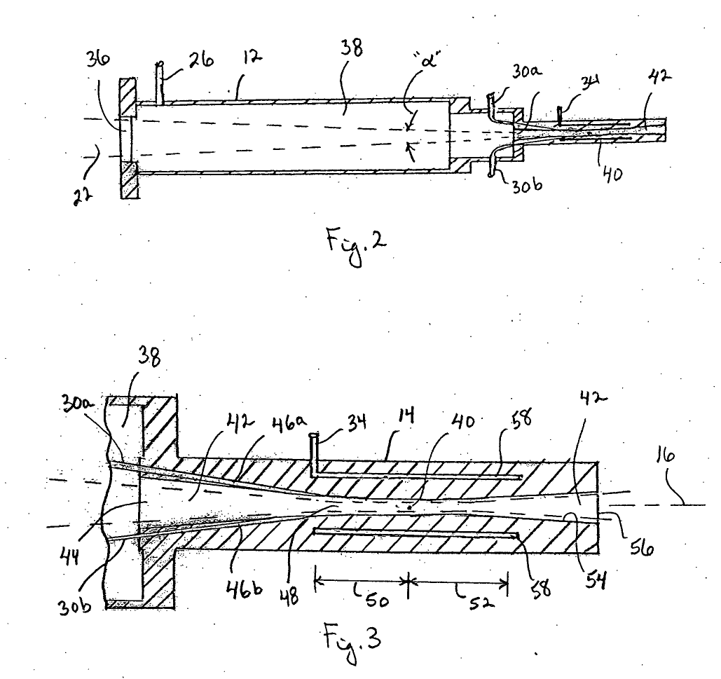

As envisioned for the present invention, gas from the gas source 24 will preferably be either Argon, Hydrogen or Helium; depending on the particular application and the powder that is to be vaporized. It is also envisioned that the powder to be vaporized will be a ceramic material, and include particles that have respective diameters “D” in a range of five to thirty microns. In any event, it is preferable that the diameter of individual particles in the powder to be vaporized be less than the “d” of the laser beam 22 that is being used to vaporize the powder (D<d). Greater detail for the structure of the system 10 will be appreciated with reference to FIG. 2.

In FIG. 2, it will be seen that a window 36 may be positioned at one end of the chamber 12. One purpose of this window 36 is to allow the laser beam 22 to be directed from the laser source 18 and through the cavity 38 of chamber 12, for focus at a focal point 40 in the channel 42 of conduit 14. Another purpose of the window 36 is to require that gas entering the cavity 38 through line 26 from the gas source 24 be directed to exit from the chamber 12 through the channel 42 of conduit 14. The consequence of this structure is, therefore, at least two-fold. For one, an over-pressure of gas in the cavity 38 prevents deposits of powder material, or the vapors thereof, to collect on the window 36. For another, this same over-pressure will force powder material from the powder source 28 through the channel 42 and away from the chamber 12.

Structural details of the conduit 14 are perhaps best seen with reference to FIG. 3. There it will be appreciated that the laser beam 22 enters the channel 42 of conduit 14 through its upstream (proximal) end 44. The laser beam 22 is thus focused to the focal point 40 in channel 42. It is also to be noted that gas from the cavity 38 of chamber 12 enters the channel 42 of conduit 14 through the upstream (proximal) end 44. Further, as best seen in FIG. 3, the conduit 14 is formed with nozzles 46a and 46b that are respectively connected to the lines 30a and 30b leading from powder source 28. Thus, the powdered material is introduced into a region 48 of the laser beam 22 at a point that is upstream from the focal point 40. In detail, the region 48 can be described as having both a proximal section 50 that extends upstream through a distance “L₁” from the focal point 40, and a distal section 52 that extends downstream through a distance “L₂” from the focal point 40. Preferably, in each instance the distance “L” for proximal section 50 and distal section 52 is less than twenty centimeters. Further, the proximal section 50 is formed with a taper angle “α” having a decreasing taper in the distal direction. Similarly, the distal section 52 may be formed with the same taper angle “α” having an increasing taper in the distal direction. Recall, the laser beam 22 is focused into the channel 42 of conduit 14 to converge/diverge with the angle “α”. The consequence of this is that the laser beam 22 can be controlled so that it will be distanced no more than approximately one millimeter from the inside wall 54 of the channel 42, everywhere in the channel 42.

In the operation of the system 10, gas from the gas source 24 is directed into the cavity 38 of chamber 12 to create an over-pressure in the cavity 38. The laser source 18 and optical arrangement 20 are then activated to focus the laser beam 22 to the focal point 40 in channel 42 of the conduit 14. Preferably, this activation of the laser beam 22 will establish a laser power density in the region 48 that is equal to approximately 1GW/m². Next, powdered material from the powder source 28 is introduced into the proximal section 50 of region 48 through the lines 30a-b and their respective nozzles 46a-b. Preferably, within the region 48, the powdered material from powder source 28, and the gas from gas source 24 are metered such that the gas and the powder have a substantially same mass per unit volume in the region 48 for vaporization. It is in this region 48 that the laser beam 22 interacts with the powder material to create a vapor that exits from the conduit 14 at its distal end 56. Due to the high temperatures that are required to accomplish this vaporization, a fluid coolant (e.g. water) from source 32 can be pumped through the fluid passageways 58 that are formed into the conduit 14 to cool the conduit 14 during a vaporization operation.

While the particular System and Method for Vaporizing Powders as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for vaporizing a powder material which comprises:
a laser source for generating a laser beam;
an optical arrangement for focusing the laser beam to a focal point, wherein the beam is characterized by having a region wherein the beam has a converging/diverging angle (α) within a distance (L) extending upstream/downstream from the focal point, and has a power density above a predetermined value within the region;
a conduit formed with a channel, wherein the channel is dimensioned to conform with the laser beam in the region, when the laser beam is focused to position the focal point in the channel; and
a nozzle for directing the powdered material into the laser beam at a location upstream from the region for vaporization of the powder material by the laser beam during transit of the material through the region.

2. A system as recited in claim 1 further comprising:
an elongated, hollow chamber having a first end and a second end; and
a window mounted at the first end of the chamber, with the second end of the chamber affixed to the conduit for passing the laser beam from the laser source, through the window, and through the chamber, for focus of the laser beam into the channel of the conduit.

3. A system as recited in claim 2 further comprising:
a source of gas; and
a means for directing gas from the source of gas and into the chamber, to maintain a gas pressure in the chamber for transporting the powder material through the channel and for isolating the window from vaporized powder material.

4. A system as recited in claim 3 wherein the gas and the powder have a substantially same mass per unit volume in the region for vaporization.

5. A system as recited in claim 3 wherein the gas is selected from a group consisting of Argon, Hydrogen and Helium.

6. A system as recited in claim 1 wherein the powder comprises particles having a diameter in a range of five to thirty microns.

7. A system as recited in claim 1 wherein the conduit is made of copper.

8. A system as recited in claim 7 wherein the conduit is formed with at least one fluid passageway for passing water therethrough to cool the conduit during vaporization of the powder material.

9. A system as recited in claim 1 wherein the distance “L” is less than twenty centimeters.

10. A system as recited in claim 1 wherein the predetermined power density is 1GW/m².

11. A system as recited in claim 1 wherein the powder material includes ceramic powders.

12. A system for vaporizing a powder material which comprises:
an elongated conduit having a proximal end and a distal end and formed with a channel extending therebetween, wherein said channel is characterized by a proximal section having a taper of diminishing cross-sectional area in a distal direction, and a distal section having a taper of increasing cross-sectional area in the distal direction;
a laser element for focusing a laser beam to a point in said channel between the proximal section and the distal section thereof, wherein said laser beam is dimensioned to substantially conform to said channel, to establish a region having a converging/diverging angle (α) within a distance (L) extending upstream/downstream from the focal point, and wherein said laser beam has a power density above a predetermined value within the region; and
a nozzle for directing the powdered material into the laser beam at a location upstream from the region for vaporization of the powder material by said laser beam during transit of the material through the region.

13. A system as recited in claim 12 further comprising:
an elongated hollow chamber having a first end and a second end;
a window mounted at the first end of the chamber, with the second end of the chamber affixed to the proximal end of the conduit for passing the laser beam from the laser source, through the window, and through the chamber, for focus of the laser beam into the channel of the conduit;
a source of gas; and
a means for directing gas from the source of gas and into the chamber, to maintain a gas pressure in the chamber for transporting the powder material through the channel and for isolating the window from vaporized powder material.

14. A system as recited in claim 13 wherein the gas and the powder have a substantially same mass per unit volume in the region for vaporization.

15. A system as recited in claim 12 wherein the powder comprises particles having a diameter in a range of five to thirty microns.

16. A system as recited in claim 12 wherein the conduit is made of copper and is formed with at least one fluid passageway for passing water therethrough to cool the conduit during vaporization of the powder material.

17. A system as recited in claim 12 wherein the distance “L” is less than twenty centimeters and wherein the angle “α” is less than approximately six degrees and the laser beam in the channel is distanced from the conduit by approximately one millimeter.

18. A method for vaporizing a powder material which comprises the steps of:
providing a system having a laser source for generating a laser beam, an optical arrangement for focusing the laser beam, and a conduit formed with a channel;
directing a stream of powder material for flow through a region in the channel;
configuring the laser beam to dimensionally conform with the region in the channel of the conduit;
focusing the laser beam to a point in the region;
orienting the laser beam to establish a power density above a predetermined value in the region; and
controlling the introduction of powder material into the stream to maximize the vaporization of the powder material in the region.

19. A method as recited in claim 18 wherein the beam is characterized by having a converging/diverging angle (α) within a distance (L) extending upstream/downstream from the focal point, and has a power density above a predetermined value within the region, and further wherein the channel is dimensioned to conform with the laser beam in the region, when the laser beam is focused to position the focal point in the channel.

20. A method as recited in claim 19 wherein the controlling step is accomplished using a nozzle for directing the powdered material into the laser beam at a location upstream from the region for vaporization of the powder material by the laser beam during transit of the material through the region.
